(19) United States
(12) Patent Application Publication
(10) Pub. No.: US 2012/0044088 A1
(43) Pub. Date: Feb. 23, 2012

(54) DEVICE MANAGEMENT SYSTEM, METHOD AND APPARATUS

(75) Inventors: Atsushi Watanabe, West Caldwell, NJ (US); Andy Plaza, West Caldwell, NJ (US)

(73) Assignees: RICOH AMERICAS CORPORATION, WEST CALDWELL, NJ (US); RICOH COMPANY, LTD., TOKYO (JP)

(21) Appl. No.: 12/861,120

(22) Filed: Aug. 23, 2010

(51) Int. Cl. G08B 5/22

(52) U.S. Cl. 340/870.07

(57) ABSTRACT

Apparatuses, systems and methods are provided for managing network-connected devices that employ an RFID tag.

### TECHNICAL FIELD

This disclosure relates to tools (systems, apparatuses, methodologies, computer program products, etc.) for managing network-connected devices, and in particular, such tools for managing network-connected devices that employ an RFID tag.

### BACKGROUND

In the current information age, information technology (IT) tools are extensively used in enterprises and other organizations in order manage the operation of network-connected devices such as multi-function devices (MFDs).

A conventional device management system may be used by a network administrator to install and manage a plurality of network-connected devices. FIG. 1 depicts an example of such a system 100, where the plurality of network-connected devices 12-1 through 12-4 exchange documents and data via the network 11, and the plurality of network-connected devices are registered and managed by the device management apparatus 15.

There is a drawback, however, in that a network administrator is often forced to manually maintain location information corresponding to the network-connected devices. For example, when a device is first installed and connected to a network, the network administrator must determine an appropriate description for the location of the network-connected device, such as a description like “across from RJM”, and then network administrator must manually enter and register this location information.

FIG. 2A depicts an example of location information corresponding to a plurality of network-connected devices that must be manually maintained by a network administrator. That is, when each of the network-connected devices is installed, the network administrator is forced to manually enter (i.e. physically type in) a location description, such as “across from RJM” as seen in FIG. 2B.

There exists a need for an improved system for managing network-connected devices which is not as difficult and time-consuming to use.

### SUMMARY

This disclosure provides tools (in the form of systems, apparatuses, methodologies, computer program products, etc.) for managing network-connected devices.

In an aspect of this disclosure, there is provided a device management apparatus (for managing a network-connected device including an RFID tag) which comprises a management information generation part configured to generate device location information indicating a location of the network-connected device, based on at least one sensor reading from an RFID sensor indicating a location of the RFID tag, the sensor reading being communicated to the device management apparatus via the network, and a device installer part configured to register a device location attribute corresponding to the network-connected device, wherein the device installer part automatically registers the device location information generated by the management information generation part as the device location attribute corresponding to the network-connected device.

In an another aspect, a device management apparatus receives tag identification information identifying an RFID tag from a network-connected device via a network, and a management information generation part of the device management apparatus generates device location information after an RFID sensor receives an identification signal from the RFID tag that matches the tag identification information received from the network-connected device.

In another aspect, a device management apparatus maintains sensor information identifying an RFID sensor and a corresponding sensor location of the RFID sensor, and if the RFID sensor detects an RFID tag of a network-connected device, the device management apparatus generates the device location information based on the corresponding sensor location of the RFID sensor.

In another aspect, a device installer of a device management apparatus includes a user interface configured for user entry of a device location attribute corresponding to a network-connected device, and the user interface automatically enters the device location information generated by a management information generation part as the device location attribute corresponding to the network-connected device.

In another aspect, a device management apparatus generates a history log indicating changes in the location of a network-connected device.

In another aspect, after an RFID sensor first detects an RFID tag of a network-connected device at a first time, a management information generation part generates device management information indicating that the network-connected device was installed at the first time.

In another aspect, after an RFID sensor first detects an RFID tag of a network-connected device at a first time, a device installer automatically registers the first time as a device installation time attribute corresponding to the network-connected device.

In another aspect, a device management apparatus generates tag location information indicating a location of an RFID tag of a network-connected device, based on at least one sensor reading of an RFID sensor, and device location information is generated based on the tag location information.

### BRIEF DESCRIPTION OF THE DRAWINGS

The aforementioned and other aspects, features and advantages can be more readily understood from the following detailed description with reference to the accompanying drawings wherein:

FIG. 1 shows a block diagram of a conventional system;

FIGS. 2A and 2b show examples of a user interface of a conventional system;

FIG. 3 shows a block diagram of a system, according to an exemplary embodiment of this disclosure;

FIG. 4 shows an example of device location information;

FIG. 5 shows an example of a user interface of a device installer;

FIG. 6 shows an example of a workflow on a device management apparatus side;

FIG. 7 shows an example of a history log;

FIG. 8 shows an example of device management information;

FIG. 9 shows another example of a user interface of a device installer;

FIG. 10 shows an example of a more detailed workflow on a device management apparatus side;

FIG. 11A shows an example of information in a detection signal;

FIG. 11B shows an example of sensor information;

FIG. 11C shows an example of tag location information;

FIG. 11D shows an example of tag identification information;

FIG. 12 shows an example of how a device management apparatus receives tag identification information and a detection signal;

FIG. 13 shows an example of a more detailed workflow on a device management apparatus side;

FIG. 14 shows a schematic view of an example of a data flow in an exemplary embodiment;

FIG. 15 shows a block diagram of a system, according to another exemplary embodiment of this disclosure;

FIG. 16A shows an example of sensor information;

FIG. 16B shows an example of tag location information;

FIG. 16C shows an example of device location information;

FIGS. 17 through 19 show block diagrams of systems with different network arrangements, according other exemplary embodiments of this disclosure;

FIG. 20 shows a block diagram of an exemplary configuration of a device management apparatus; and

FIG. 21 shows a block diagram of an exemplary configuration of a network-connected device.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations will be omitted when it may obscure the subject matter of the present invention.

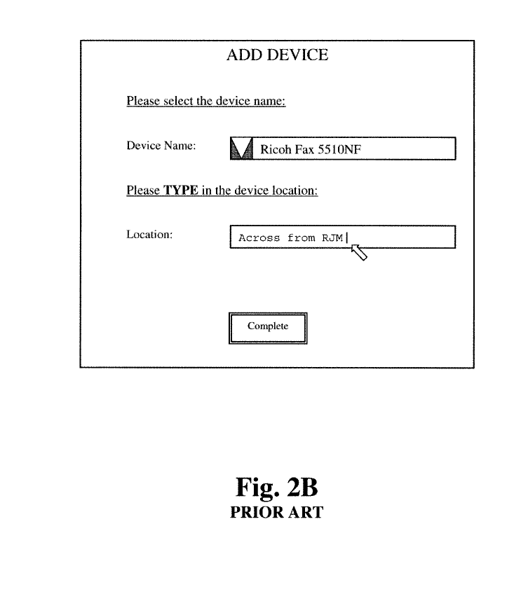

Referring now to the drawings, wherein like reference numerals designate identical or corresponding parts throughout the several views, FIG. 3 shows schematically a system 300 for managing a network-connected device, where the system 300 is an active system.

System 300 includes a network-connected device 32, an RFID sensor 35, and a device management apparatus 37, all of which are interconnected by a network 31.

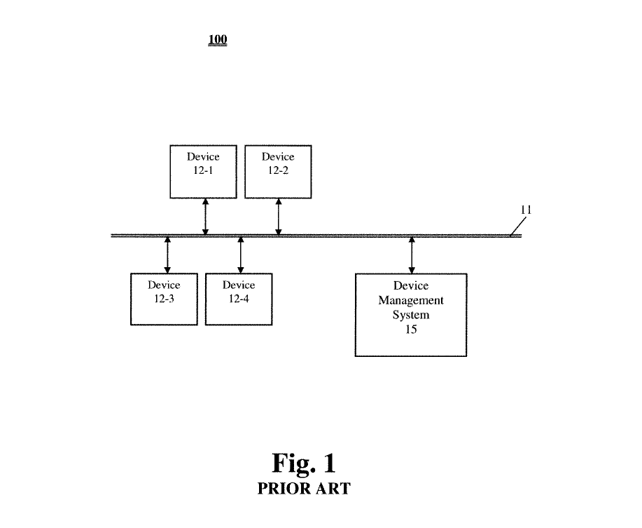

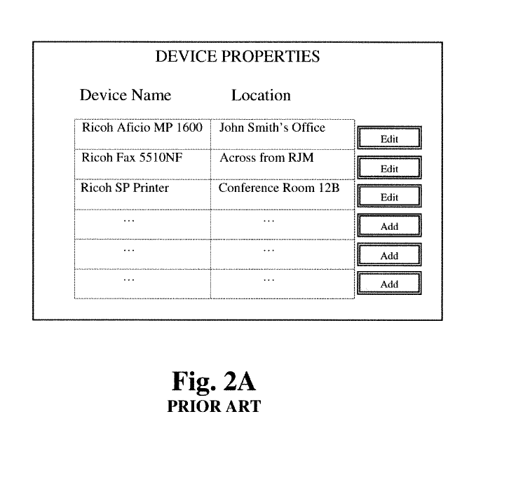

The network-connected device 32 may be substantially similar to any of the plurality of devices 12-1 through 12-4 connected to the network 11 depicted in FIG. 1. For example, the network-connected device 32 may be a client terminal or any computing device including but not limited to a personal, notebook or workstation computer, a kiosk, a PDA (personal digital assistant), a scanner, a printer, a facsimile machine, an MFD (multi-function device), a server, a mobile phone or handset, another information terminal, etc. The network-connected device 32 is configured with software allowing the network-connected device to communicate through the network 31 with at least the device management apparatus 37. In particular, network-connected device 32 may transmit data to, and receive data from, the device management apparatus 37.

The network-connected device 32 includes a Radio Frequency Identification (RFID) tag 32a, as seen in FIG. 3. The RFID tag 32a is configured to be detectable by the RFID sensor 35, and the RFID tag 32a and the RFID sensor 35, collectively, may form an RFID detection system. There are many ways to implement such an RFID detection system, and one example of such an RFID detection system is described as follows.

The RFID tag 32a (which may also be referenced as an RFID “label”) may include (not shown) an integrated circuit (or another solid state device) for storing and processing information, such as information identifying the RFID tag and information identifying and describing the network-connected device 32. The RFID tag 32a may also include an antenna (not shown), such as constructed from, for example, a flat coil of wire, for receiving and transmitting radio signals. The RFID tag 32a is configured to receive a radio frequency signal transmitted from the RFID sensor 35, and to transmit information back to the RFID sensor 35 in response to a received information request from the RFID sensor, with the use of the RFID tag's antenna. For instance, the radio signal transmitted from the RFID sensor 35 and received by the RFID tag 32a may be a request for information stored in the integrated circuit of the RFID tag 32a. The RFID tag 32a may respond by transmitting the requested information back to the RFID sensor 35.

The RFID tag 32a may be, for example, an active RFID tag or a passive RFID tag. An active RFID tag contains an internal or local battery to power the various components of the active RFID tag (including the integrated circuit and the antenna of the RFID tag), and in such example, the RFID tag may transmit signals autonomously to the RFID sensor 35 or to other destinations. On the other hand, a passive RFID tag does not contain a local battery or power supply, but instead requires an external source of power in order to operate. Typically, once a passive RFID tag receives a radio frequency signal from an RFID sensor or reader, such as RFID sensor 35, the passive RFID tag converts the radio frequency signal itself into a source of power for the passive RFID tag. The RFID tag 32a may either be embedded, or otherwise located internally, within the network-connected device 32, or may be affixed or attached externally to the network-connected device 32. In another example, the RFID tag 32a is positioned in close physical proximity to the network-connected device 32, without being directly attached to the network-connected device 32. Other variants and examples of RFID tag 32a are also possible. For example, the RFID tag 32a may be configured as a two-way RFID transponder.

The RFID sensor 35 (also known as an RFID reader, scanner or interrogator) is configured to transmit radio frequency signals to the RFID tag 32a included in the network-connected device 32 (or another RFID device), and to receive signals or information from the RFID tag 32a. For example, as described above, the RFID sensor 35 may transmit a signal to the RFID tag 32a requesting information stored in the RFID tag 32a (such as information identifying the RFID tag 32a, information identifying the network-connected device 32, etc), and the RFID sensor may receive a response from the RFID tag 32a containing the requested information. Since the transmission range of the radio-frequency signals transmitted by the RFID sensor may be somewhat limited (for example, up to 10 meters), the RFID sensor 35 is able to communicate with the RFID tag 32a only when the RFID sensor 35 is within the transmission range and is thus in relatively close physical proximity to the RFID tag 32a. In this manner, the RFID sensor 35 is able to detect the presence of the RFID tag 32a (as well as receive information from the RFID tag and identify the RFID tag 32a and/or the network-connected device 32) when the RFID tag 32a is in close physical proximity to the RFID sensor 35. The RFID sensor 35 may be positioned strategically at or near a location to which the network-connected device 32 may be brought.

Device management apparatus 37 of FIG. 3 includes a management information generation part 37a and a device installer (including, for example, a program) 37c.

The management information generation part 37a of the device management apparatus 37 is configured to generate device location information indicating a location of the network-connected device 32. In particular, the management information generation part 37a is configured to generate the device location information based on at least one detection signal from the RFID sensor 35 indicating a location of the RFID tag 32a.

That is, if the RFID sensor 35 is able to detect and identify the RFID tag 32a included in the network-connected device 32, the RFID sensor 35 generates a detection signal that indicates a location of the RFID tag 32a or may be directly utilized to determine the location of the RFID tag. For example, the detection signal may indicate that the network-connected device 32 has been detected and may include information regarding the installation location of the RFID sensor 35 itself. Alternatively, the device management apparatus 37 may store information regarding the installation location of the RFID sensor 35. The detection signal from the RFID sensor 35 is communicated to the management information generation part 37a of the device management apparatus 37 via the network 31.

Based on this detection signal, the location of the RFID tag 32a included in the network-connected device, and thus the location of the network-connected device 32 itself, may be ascertained, and the management information generation part 37a generates the device location information indicating a location of the network-connected device 32.

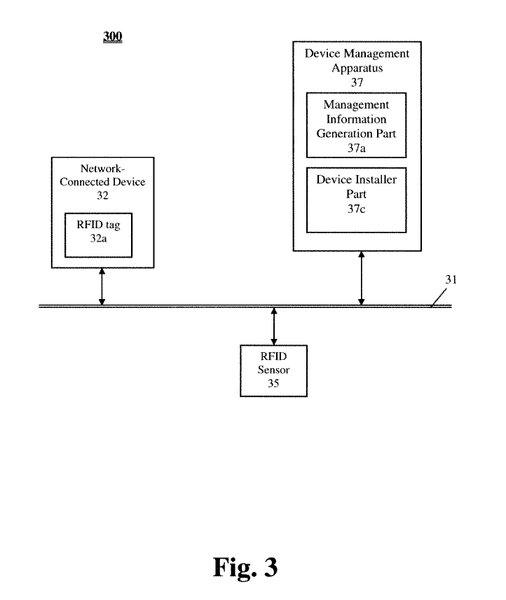

An example of a device location information that is generated by the management information generation part 37a and that indicates a location of a network-connected device is depicted in FIG. 4. The device location information includes a device name that identifies the network-connected device, in this example “Ricoh Scanner”. This Ricoh Scanner device may correspond to the network-connected device 32 depicted in FIG. 3. The device location information also includes a device location of the network-connected device, in this example “Reception Area.” Thus, the device location information generated by the management information generation part 37a indicates a location of the network-connected device.

The device installer 37c of the device management apparatus 37 is configured to register a device location attribute corresponding to the network-connected device. The device installer 37c may thus be a registration, installation or device driver-type application functionality that registers various information of the network-connected device, in order to ensure the efficient and proper operation of the network-connected device as it is connected to the network.

In particular, according to this exemplary embodiment, the device installer 37c of this disclosure is configured to automatically register the device location information (depicted in FIG. 4, for example), as generated by the management information generation part 37a of the device management apparatus 37, as the device location attribute corresponding to the network-connected device 32.

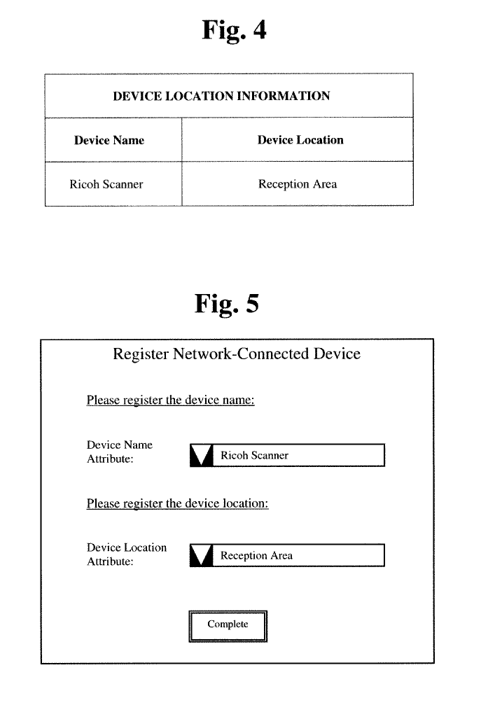

FIG. 5 depicts an example of a user interface of the device installer 37c that is configured for user entry of a device location attribute corresponding to a network-connected device. In particular, FIG. 5 shows the automatic registration, by the device installer 37c, of the device location information (depicted in the example of FIG. 4) as the device location attribute corresponding to the network-connected device. That is, the device installer 37c automatically enters and registers “Reception Area” as a device location attribute corresponding to the network-connected device. This is down without any user input, except for possibly requiring user approval by clicking the “Complete” button, as depicted in FIG. 5. (It should be understood that the device installer 37c may register the device location information in software in a manner transparent to the user, i.e. without presenting a user interface such as that depicted in FIG. 5 to a user).

Thus, according to this exemplary embodiment of this disclosure, there is provided the tools for the efficient management of a network-connected device. Whereas conventional techniques typically require a user or network administrator to manually determine, enter and register a device location attribute corresponding to the network-connected device, the device management apparatus of this disclosure automatically generates device location information indicating a location of a network-connected device, and automatically registers this device-location information as a device location attribute corresponding to the network-connected device. Thus, a user may more efficiently and easily manage a network-connected device.

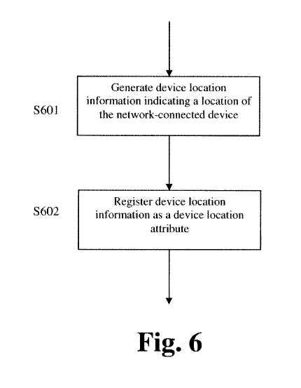

Turning now to FIG. 6, there is shown an example of a workflow on a device management apparatus side, such as the device management apparatus 37 in FIG. 3.

In S601, the device management apparatus generates device location information indicating a location of the network-connected device. An example of such device location information is depicted in FIG. 4. The device location information is generated based on at least one detection signal from an RFID sensor indicating a location of an RFID tag included in the network-connected device. The detection signal may be communicated to the device management apparatus via the network.

In S602, a device installer of the device management apparatus automatically registers the device location information generated in S601, as a device location attribute corresponding to the network-connected device. FIG. 5 illustrates the automatic registration, in a user interface of the device installer, of the generated device location information (in the example of FIG. 4) as the device location attribute corresponding to the network-connected device.

According to this exemplary embodiment, the detection signals from the RFID sensor 35 may be generated and communicated to the device management apparatus 37 at predetermined intervals. For example, the detection signals may be generated and communicated to the device management apparatus 37 once every minute, once every hour, or once every day, for example.

Thus, when the network-connected device 32 is moved, the RFID sensor may detect the movement of the network-connected device, and a detection signal generated by the RFID sensor 35 after the network-connected device 32 (and the RFID tag 32a) is moved will reflect the updated location of the network-connected device. Based on this detection signal, the management information generation part 37a will generate device location information that is updated to reflect the updated location of the network-connected device 32. This device location information may then be registered as the device location attribute corresponding to the network-connected device, by the device installer 37c as discussed above.

According to another aspect of this disclosure, the management information generation part 37c generates a history log indicating changes in the location of the network-connected device 32. That is, whenever the network-connected device 32 is moved and the device location information is updated to reflect the updated location of the network-connected device 32, the management information generation part 37c may generate and/or edit a history log that keeps track of all the changes in the location of the network-connected device 32.

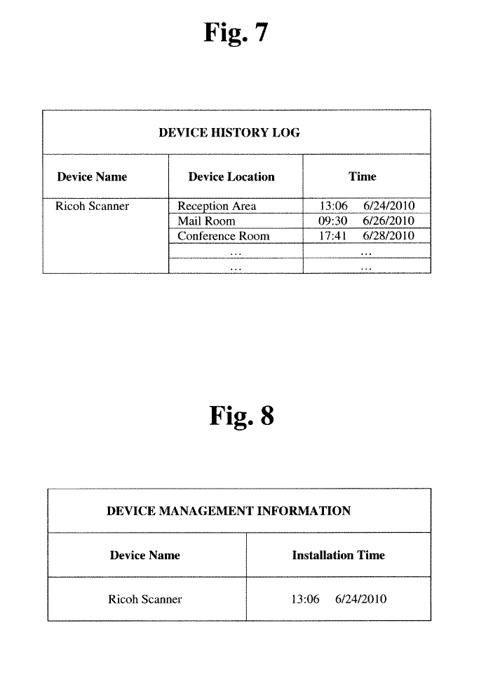

FIG. 7 depicts an example of a device history log generated by the management information generation part 37c that indicates changes in the location of the network-connected device. The device history log may include a device name used to identify the network-connected device, in this example “Ricoh Scanner”. The device history log may also include a device location field indicating changes in the location of the network-connected device (“Reception Area”, “Mail Room”, “Conference Room”) and a corresponding time when it was determined that the network-connected device was located at the corresponding location.

Thus, whereas conventional techniques typically require a network administrator to manually maintain information tracing the installation locations of the network-connected device, according to this aspect of this disclosure, the device management apparatus automatically generates a history log indicating changes in the location of the network-connected device. Thus, this reduces the network-administrator's efforts, and provides greater traceability regarding ‘where’ and ‘when’ a network-connected device is moved.

In another aspect of this disclosure, the device management apparatus 37 generates device management information indicating when the network-connected device 32 was installed. This is accomplished by equating the installation time of the network-connected device 32 to the time shortly after when the RFID sensor 35 first detects the RFID tag 32a and accordingly generates the first detection signal. That is, after the RFID sensor 35 first detects the RFID tag 32a at a first time, or after the management information generation part 37a first receives a detection signal corresponding to the network-connected device 32 at a first time, the management information generation part 37a then generates device management information indicating that the network-connected device was installed at the first time.

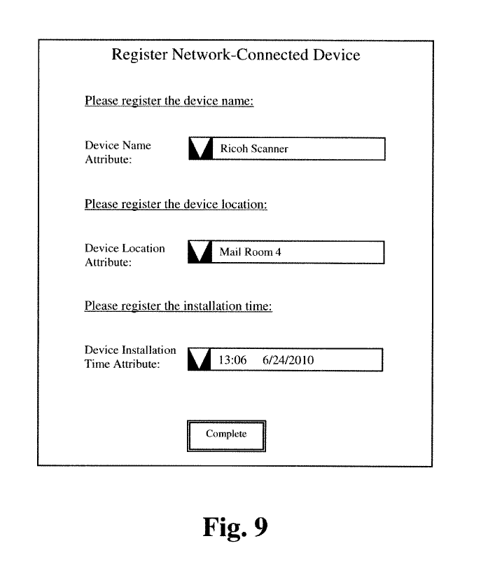

FIG. 8 depicts an example of device management information indicating when the network-connected device 32 was installed. The device management information includes a device name for identifying the device, in this example “Ricoh Scanner”, The device management information also includes an installation time indicating that the network-connected device was installed at: 13:06 Jun. 24, 2010. Thus, this installation time corresponds to either the first time the RFID sensor 35 first detected the RFID tag 32a, or the first time the management information generation part 37a received a detection signal from the RFID sensor 35 corresponding to the network-connected device 32.

Note also that this installation time corresponds to the first time indicated in the history log depicted in FIG. 7. That is, the time entries of the history log may be generated in a similar manner: the first time the RFID sensor 35 first detects a new location of the RFID tag 32a, or the first time the management information generation part 37a receives a detection signal from the RFID sensor 35 corresponding to a new location of the network-connected device 32, may be recorded as the ‘Time’ entry in the history log, as depicted in FIG. 7.

In another aspect of this disclosure, information indicating when the network-connected device 32 was installed is automatically registered, by the device installer 37c, as a device installation time attribute corresponding to the network-connected device 32. That is, in much the same way that the device installer 37c automatically registers the device location information generated by the management information generation part 37a as a device location attribute corresponding to the network-connected device, the device installer 37c may also automatically register an installation time as a device installation time attribute corresponding to the network-connected device 32.

Thus, after the RFID sensor 35 first detects the RFID tag 32a at a first time, or after the management information generation part 37a first receives a detection signal corresponding to the network-connected device 32 at a first time, the device installer automatically registers the first time as a device installation time attribute corresponding to the network-connected device.

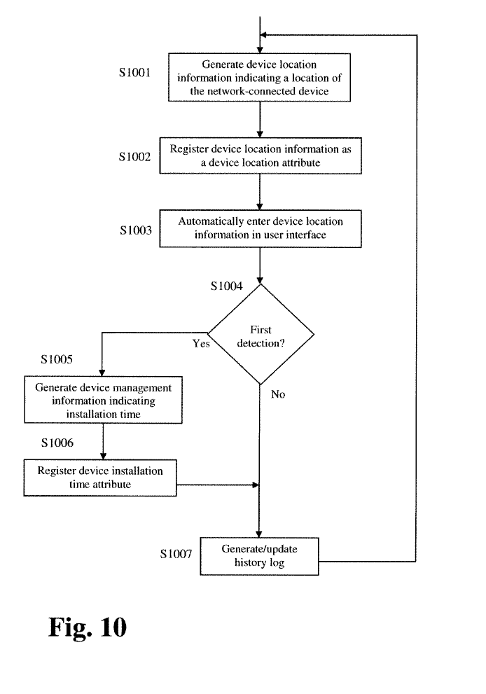

FIG. 9 depicts an example of a user interface of the device installer 37c, where the device installer automatically enters a time as a device installation time attribute corresponding to the network-connected device. This is down without any user input, except for possibly requiring user approval by clicking the “Complete” button, as depicted in FIG. 9. Thus, the network administrator does not have to manually enter and register such information. (It should be understood that the device installer 37c may register the device installation time attribute in software in a manner transparent to the user, i.e. without presenting a user interface such as that depicted in FIG. 9 to a user)

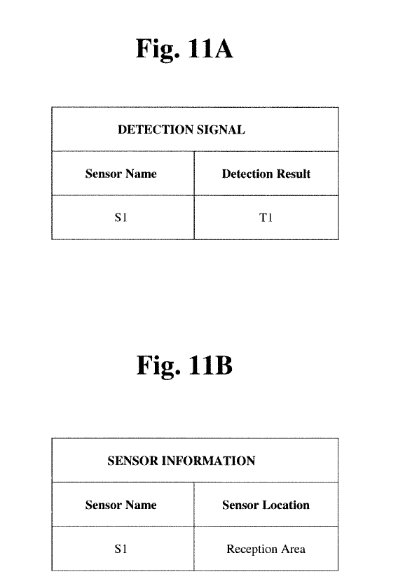

Turning now to FIG. 10, there is shown an example of a more detailed workflow on a device management apparatus side, such as the device management apparatus 37 in FIG. 3.

Steps S1001 and S1002 are substantially similar to steps S601 and S602 as depicted in FIG. 3.

In S1003, the device installer automatically enters the device location information generated in S1001 as the device location attribute corresponding to the network-connected device, in a user interface of the device installer configured for user entry of the device location attribute. An example of such a user interface is depicted in FIG. 5

In S1004, the device management apparatus determines whether this is the first time the RFID sensor has detected the RFID tag included in the network-connected device (or alternatively, if this is the first time the device management apparatus has received a detection signal corresponding to the network-connected device from the RFID sensor).

If the device management apparatus reaches a negative determination (S1004, no), then the workflow proceeds to step S1007. If the device management apparatus reaches a positive determination (S1004, yes),the device management apparatus generates device management information indicating that the network-connected device was installed at a first time (S1005), where the RFID sensor first detected the RFID tag at the first time (or alternatively where the device management apparatus first received a detection signal corresponding to the network-connected device from the RFID sensor at a first time). An example of device management information is depicted in FIG. 8.

Then in S1006, the device installer of the device management apparatus registers the first time as a device installation time attribute corresponding to the network-connected device, where the RFID sensor first detected the RFID tag at the first time (or alternatively where the device management apparatus first received a detection signal corresponding to the network-connected device from the RFID sensor at the first time). FIG. 9 depicts an example of a user interface of the device installer, where the device installer automatically enters a time as a device installation time attribute corresponding to the network-connected device.

Finally, in S1007 the device management apparatus generates (or updates) a history log indicating changes in the location of the network-connected device, if any such changes have occurred. An example of such a history log is depicted in FIG. 7. The workflow then returns to S1001 and repeats again.

Note that steps S1004 through S1007 need not necessarily occur after steps S1002 and/or S1003, but may occur any time after S1001.

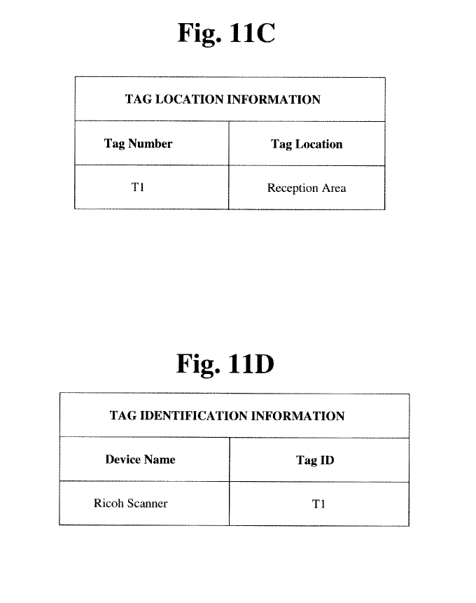

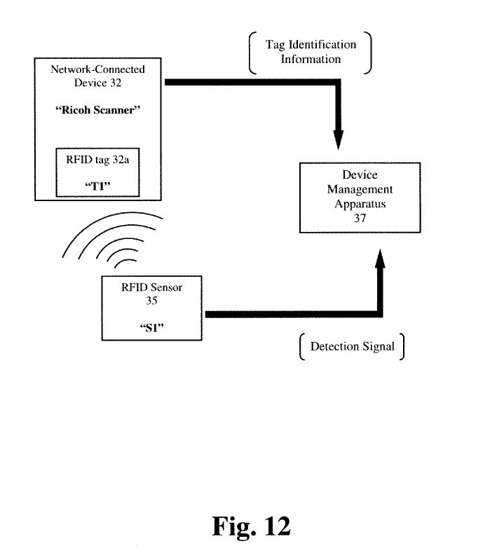

Turning now to FIGS. 11A through 11D and FIG. 12, aspects regarding the generation of the device location information, based on at least one detection signal from the RFID sensor 35, are discussed in more detail.

An example of the information included in the detection signal generated by the RFID sensor 35 and received at the device management apparatus is depicted in FIG. 11A. The detection signal includes a sensor name that identifies the RIFD sensor 35, and a detection result indicating that the RFID sensor 35 has detected the RFID tag 32a. In the example of FIG. 11A, the sensor name is “S1” (corresponding to the RFID sensor 35), and the detection result indicates that the sensor S1 can communicate the RFID tag “R1” (corresponding to the RFID tag 32a). Thus, the detection result indicates that the RFID sensor 35 is in close physical proximity to the RFID tag 32a and is able to communicate with the RFID tag 32a and read identification information from the RFID tag 32a.

The device management apparatus 37 may also maintain sensor information identifying the RFID sensor 35 and a corresponding sensor location of the RFID sensor 35. An example of sensor information is depicted in FIG. 11B. As seen in FIG. 11B, the sensor information includes a sensor name identifying the RFID sensor 35 and a corresponding sensor location of the RFID sensor 35. In the example of FIG. 11B, the sensor name is “S1” (corresponding to the RFID sensor 35), and the corresponding sensor location is “Reception Area”.

The management information generation part 37a of the device management apparatus 37 may then generate tag location information indicating the location of the RFID tag 32a, based on detection signal from the RFID sensor 35 and the sensor information maintained at the device management apparatus 37. That is, if the detection signal indicates that the RFID sensor 35 has detected the RFID tag 32a, and the sensor information indicates a corresponding location of the RFID sensor 35, then the management information generation part 37a may determine that the RFID tag 32a is also located at the corresponding location of the RFID sensor 35.

FIG. 11C illustrates an example of tag location information indicating a location of the RFID tag T1, generated based on the detection result of FIG. 11A and sensor information of FIG. 11B. Since the detection result in FIG. 11A indicates that sensor S1 has detected the RFID tag T1, and the sensor information in FIG. 11B indicates the sensor S1 is located at the Reception Area, then the generated tag location information illustrated in FIG. 11C indicates that the RFID tag T1 is located at the corresponding sensor location i.e. the Reception Area.

The management information generation part 37c may also receive tag identification information from the network-connected device 32 that identifies the RFID tag 32a included in the network-connected device 32. The management information generation part 37c uses the tag identification information to “match” the tag location information (depicted in FIG. 11C) with the corresponding network-connected device 32.

For instance, FIG. 11D depicts an example of tag identification information received at the management information generation part 37c from the network-connected device 32. The tag identification information indicates that the RFID tag T1 (corresponding to RFID tag 32a) matches the device “Ricoh Scanner” (corresponding to network-connected device 32).

The tag identification information may be transmitted from the network-connected device 32 to the device management apparatus 37 via the network 31. The device management apparatus 37 may poll or request the network-connected device 32 to respond with the tag identification information, or the network-connected device 32 may transmit the tag identification information to the device management apparatus 37 without any request from the device management apparatus 37 to do so.

The management information generation part 37c may then generate the device location information, based on the tag location information and the tag identification information. For example, based on the tag location information depicted in FIG. 11C (which indicates that tag T1 is located in the Reception Area) and the tag identification information depicted in FIG. 11D (which indicates that the tag T1 is included in the Ricoh Scanner device), the management information generation part 37c generates the device location information depicted in FIG. 4 (which indicates that the Ricoh Scanner device is located in the Reception Area).

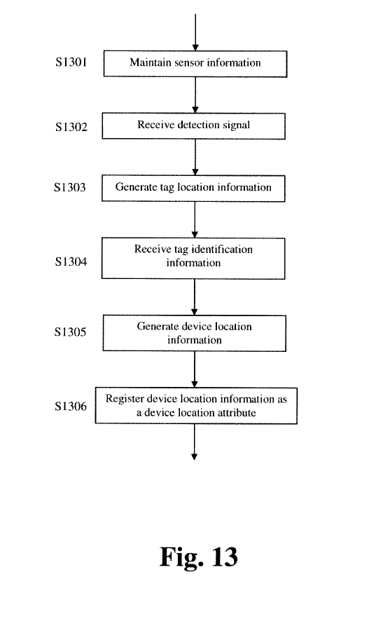

In FIG. 13, there is shown an example of a more detailed workflow on a device management apparatus side, such as the device management apparatus 37 in FIG. 3.

In S1301, the device management apparatus maintains sensor information identifying an RFID sensor and a corresponding sensor location of the RFID sensor. An example of sensor information is depicted in FIG. 11B. In S1302, the device management apparatus receives a detection signal from an RFID sensor, where the detection result identifies the RFID sensor and a tag detected by the RFID sensor. An example of the information included in a detection signal is illustrated in FIG. 11A.

In S1303, the device management apparatus generates tag location information indicating a location of the RFID tag. The tag location information is generated based on the detection result received from the RFID sensor in S1302 (which indicates that the RFID sensor has detected the RFID tag) and the sensor information maintained by the device management apparatus in S1301 (which indicates the location of the RFID sensor). That is, the tag location information equates the tag location to the corresponding sensor location of the RFID sensor that detects the RFID tag. An example of tag location information is illustrated in FIG. 11C.

In S1304, the device management apparatus receives, from the network-connected device, tag identification information identifying the network connected device and identifying the RFID tag included in the network connected device. An example of tag identification information is illustrated in FIG. 11D. Then in S1305, the device management apparatus generates device location information indicating the location of the network-connected device. The device location information is generated based on the tag location information generated in S1303 (which indicates a location of the RFID tag) and the tag identification information received in S1304 (which identifies the network-connected device in which the RFID tag is included). That is, the device location information equates the device location to the corresponding tag location of the RFID tag included in the network-connected device. An example of device location information is shown in FIG. 4.

Finally, in S1306, a device installer of the device management apparatus automatically registers the device location information generated in S1305, as a device location attribute corresponding to the network-connected device.

According to an aspect of this embodiment, if the RFID sensor detects the RFID tag, the management information generation part 37c generates the tag location information and device location information based on the corresponding sensor location of the RFID sensor.

However, according to another embodiment of this disclosure, the RFID sensor 35 may be programmed to store information regarding its own sensor location. Thus, the detection signal transmitted to the device management apparatus 37 may indicate that the RFID sensor 35 has detected the RFID tag 32a, and may directly include information regarding the location of the RFID sensor 35. In this way, the tag location information indicating the location of the RFID tag may be generated directly from the received detection signal, and the need to maintain sensor information (as depicted in the example of FIG. 11B) is eliminated.

According to another aspect of this embodiment, the management information generation part 37a generates the device location information after the RFID sensor receives identifying information (i.e. the detection signal identifying the RFID tag) from the RFID tag that matches the tag identification information received from the network-connected device.

However, according to another embodiment of this disclosure, the RFID tag 32a may itself be programmed to store information about the corresponding network-connected device 32, which may be read by the RFID sensor 35. Thus, the detection signal generated by the RFID sensor 35 may itself indicate the name of the network-connected device 32 (such as “Ricoh Scanner”). In this way, the need for generating tag location information (as depicted in FIG. 11C) and the need for receiving tag identification information (as depicted in FIG. 11D) from the network-connected device is eliminated. Instead, if the detection signal indicates that, for example, the RFID sensor S1 has detected the network-connected device “Ricoh Scanner”, and if sensor information indicates that, for example, the sensor S1 is located in the “Reception Area”, then the device location information as depicted in FIG. 4 (indicating that the device “Ricoh Scanner” is located in the “Reception Area”) may generated.

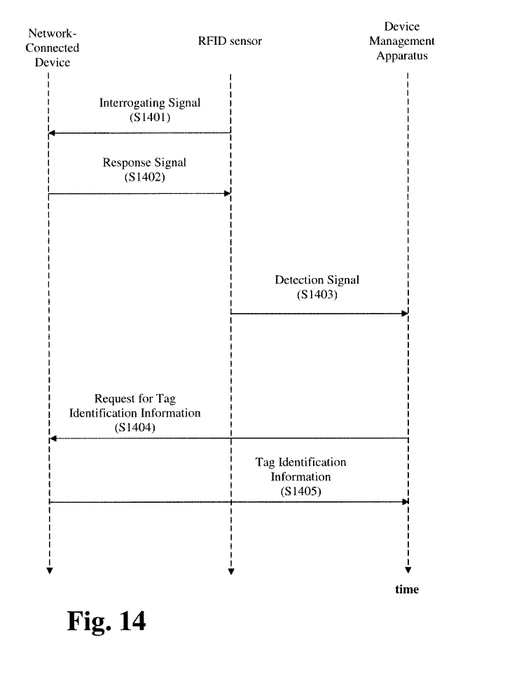

Turning now to FIG. 14, a schematic view of an example of data flow in an exemplary embodiment is presented.

In S1401, the RFID sensor transmits an interrogating signal to the RFID tag included in the network-connected device. If the RFID sensor is in close proximity to the RFID tag and is able to communicate with the RFID tag, then the RFID tag will transmit a response signal to the RFID sensor in S1402. The response signal may at least include identifying information that identifies the RFID tag.

In S1403, the RFID sensor transmits a detection signal to the device management apparatus. The detection signal may identify the RFID sensor and indicate that the RFID sensor has detected the RFID tag. An example of information included in a detection signal is depicted in FIG. 11A. Based on the detection signal, and sensor information maintained by the device management apparatus, the device management apparatus may generate tag location information indicating a location of the RFID tag.

In S1404, the device management apparatus may transmit a request for tag identification information to the network-connected device, and the device management apparatus may receive the tag-identification information from the network-connected device in S1405. An example of tag identification information is depicted in FIG. 11D. Based on the tag-identification information received in S1405 and the already generated tag location information, the device management apparatus generates device location information indicating the location of the network-connected device. An example of device location information is depicted in FIG. 4.

Thereafter, a device installer of the device management apparatus automatically registers the generated device location information, as a device location attribute corresponding to the network-connected device.

While this disclosure has discussed the generation of the device location information based on the principles of RFID technology, it should be understood that the device location information may be generated using other types of location/tracking technology that allow for the tracking of network-connected device. For example, GPS receivers within network-connected device may be utilized to generate the device location information indicating the location of the network-connected device.

While the example shown in FIG. 3 includes one network-connected device, one RFID sensor, and one device management apparatus, it should be appreciated that such numbers of devices, sensors and apparatuses are arbitrary and are selected as an example in order to facilitate discussion, and that the subject matter of this disclosure can be implemented in a system including one or more systems, servers, apparatuses and terminals. Other devices, such as scanners, printers and multi-function devices (MFDs) may also be connected to the network 31, as is well known in the art.

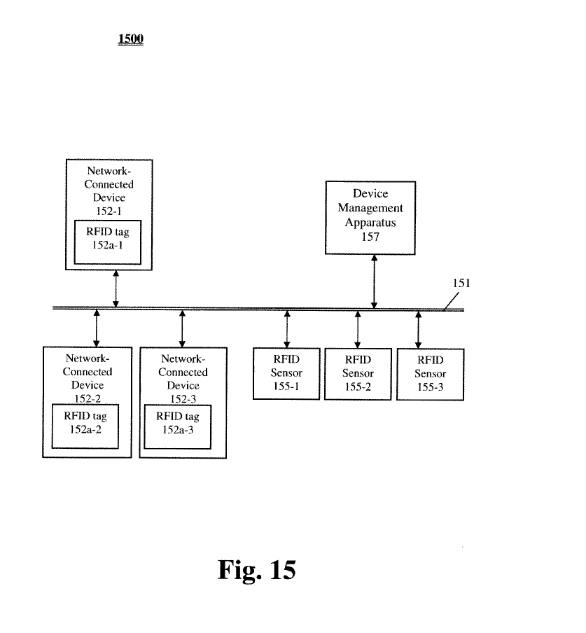

For example, in FIG. 15 there is shown schematically a system 1500 for managing a plurality of network-connected devices, according to another exemplary embodiment of this disclosure.

System 1500 is similar to system 300 depicted in FIG. 3, except that system 1500 includes a plurality of network-connected devices 152-1 through 152-3 including a corresponding plurality of RFID tags 152a-1 through 152a-3, as well as a plurality of RFID sensors 155-1 through 155-3 and a device management apparatus 157. The device management apparatus 157 is able to manage the plurality of network-connected devices 152-1 through 152-3, according to the aspects of this disclosure.

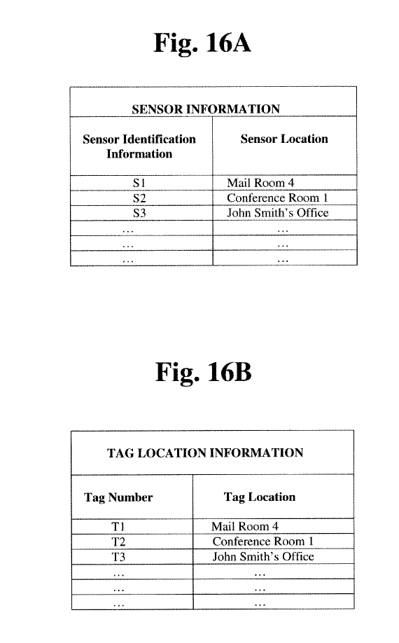

That is, the device management apparatus 127 may maintain sensor information of the plurality of sensors, as depicted in the example of FIG. 16A. If the device management apparatus 127 receives a plurality of detection signals, each indicating that a different RFID sensor has detected a different RFID tag (for example:: S1 has detected T1, S2 has detected T2, and S3 has detected T3), then the device management apparatus 157 may generate tag location information indicating the locations of the plurality of RFID tags, as illustrated in the example of FIG. 163. If the device management apparatus 157 then receives tag identification information identifying the network-connected devices corresponding to each of the tags (for example: T1=printer 1, T2=printer 2, T3=printer 3), then the device management apparatus 157 may generate device location information indicating the locations of each of the plurality of network-connected devices, as illustrated in the example of FIG. 16C.

The inclusion of a plurality of strategically-placed RFID sensors also increases the ability to detect changes in the locations of the network-connected devices, as the devices may move from the detection range of one RFID sensor to the detection range of another.

While the example shown in FIG. 3 (and FIG. 15) depicts the network-connected device(s), the RFID sensor(s), and the device management apparatus being connected to a single network, the subject matter of this disclosure can be implemented in a system with different network arrangements.

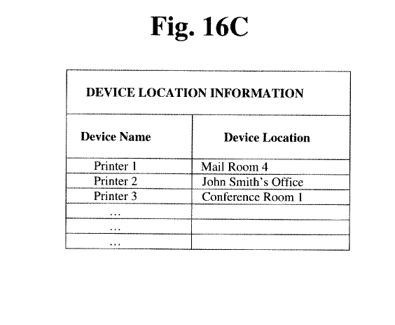

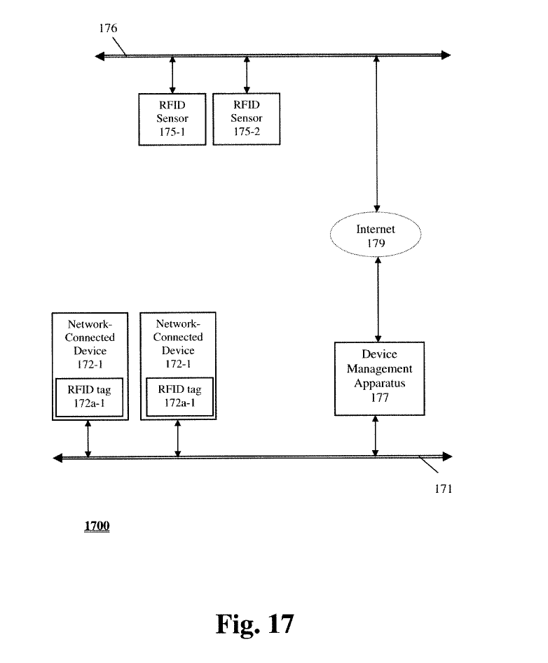

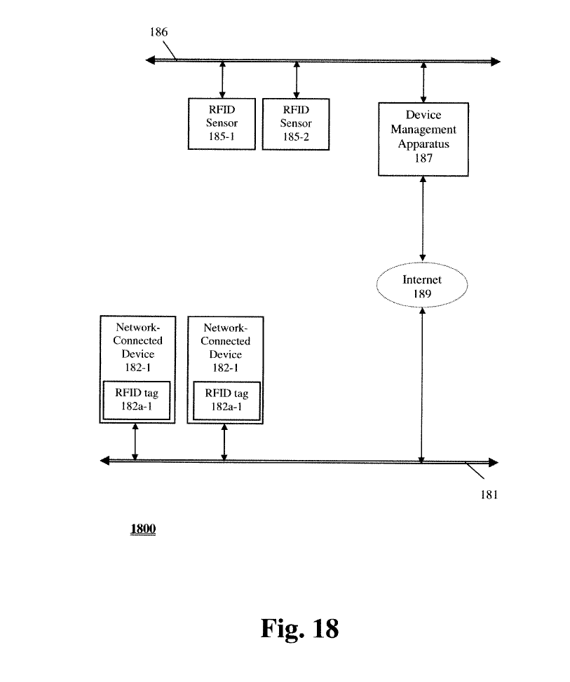

FIGS. 17 through 19, for example, depict systems 1700, 1800 and 1900 respectively, each with different network arrangements.

In system 1700, a plurality of network-connected devices 172-1 through 172-2 and a device management apparatus 177 are connected to a first network 171. Further, a plurality of RFID sensors 175-1 through 175-2 are connected to a second network 176. The device management apparatus 177 is able to communicate with the second network 176 via, for example, the Internet 179.

In system 1800, a plurality of network-connected devices 182-1 through 182-2 are connected to a first network 181. Further, a plurality of RFID sensors 185-1 through 185-2 and a device management apparatus 187 are connected to a second network 186. The device management apparatus 187 is able to communicate with the first network 186 via, for example, the internet 189.

In system 1900, a plurality of network-connected devices 192-1 through 192-2 and a device management apparatus 197 are connected to a first network 191. Further, a plurality of RFID sensors 195-1 through 195-2 and a tag location database 198 are connected to a second network 196. The tag location database 198 acts as a central hub for the information flowing from the plurality of RFID sensors 195-1 through 195-2. The tag location database may even share or assume some of the functions of the device management apparatus 197, such as receiving the detection signals from the plurality of RFID sensors 195-1 through 195-2, maintaining sensor information and generating the tag location information. The device management apparatus 197 is able to communicate with the tag location database 198 via, for example, the internet 199.

Each network-connected devices 32 can be any computing device, including but not limited to a personal, notebook or workstation computer, a kiosk, a PDA (personal digital assistant), a MFD (multi-function device), a server, a mobile phone or handset, another information terminal, etc., that can communicate through the network 31 with other devices.

The device management apparatus can be configured in software or hosted on any computing device, including but not limited to a personal, notebook or workstation computer, a kiosk, a PDA (personal digital assistant), a MFD, a server, a mobile phone or handset, another information terminal, etc., that can communicate through the network 31 with other devices.

The device management apparatus of this disclosure may be realized by a computer program product including a computer-usable, non-transient medium (such as a disk storage apparatus) having instructions tangibly embodied therein that are executed by a computer.

Thus, it should be understood that the device management apparatus may be executed on a computer. While device management apparatuses are shown as being external to the network-connected devices, the device management apparatus may in fact be executed on one of the network-connected devices.

The device management apparatus may include a data store that can comprise one or more structural or functional parts that have or support a storage function. For example, the data store can be, or can be a component of, a source of electronic data, such as a document access apparatus, a backend server connected to a document access apparatus, an e-mail server, a file server, a multi-function peripheral device (MFP or MFD), a voice data server, an application server, a computer, a network apparatus, a terminal etc. It should be appreciated that the term “electronic document” or “electronic data”, as used herein, in its broadest sense, can comprise any data that a user may wish to access, retrieve, review, etc.

The network 31 can include one or more of a secure intranet or extranet local area network, a wide area network, any type of network that allows secure access, etc., or a combination thereof. Further, other secure communications links (such as a virtual private network, a wireless link, etc.) may be used as well in the network 31. In addition, the network 31 preferably uses TCP/IP (Transmission Control Protocol/Internet Protocol), but other protocols can also be used. How devices can connect to and communicate over the network 31 is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

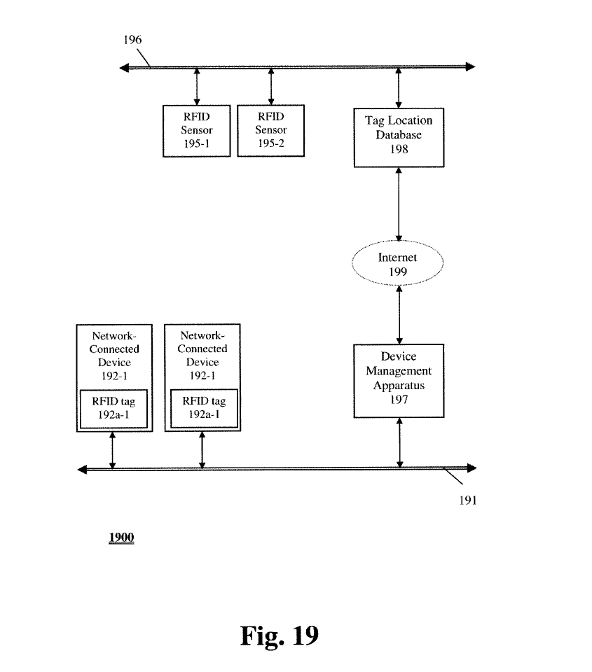

FIG. 20 shows an exemplary constitution of a device management apparatus 200 as a computer, for example, that can be configured through software to provide the device management apparatus 37 of FIG. 3. As shown in FIG. 20, the device management apparatus 200 includes a controller (or central processing unit) 201 that communicates with a number of other components, including memory or storage part 202, network interface 203, display 204 and keyboard 205, by way of a system bus 209.

The device management apparatus 200 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as will be appreciated to those skilled in the relevant arts.

In device management apparatus 200, the controller 201 executes program code instructions that control conferencing apparatus operations. The controller 201, memory/storage 202, network interface 203, display 204 and keyboard 205 are conventional, and therefore in order to avoid occluding the inventive aspects of this disclosure, such conventional aspects will not be discussed in detail herein.

The device management apparatus 200 includes the network interface 203 for communications through a network, such as communications through the network 31 with the network-connected device 32 and RFID sensor 35 in FIG. 3. However, it should be appreciated that the subject matter of this disclosure is not limited to such configuration. For example, the device management apparatus 200 may communicate with the network-connected device 32 and RFID sensor 35 through direct connections and/or through a network to which some components are not connected. As another example, the device management apparatus 200 need not be provided by a server that services terminals, but rather may communicate with the devices on a peer basis, or in another fashion.

As mentioned above, device management apparatus 37 is not limited to a server or computer, but can be manifested in any of various devices that can be configured to communicate over a network and/or the Internet.

Note that one or more of the user interfaces (such as the user interface of the device installer 37c) may be provided as web services through the network to a client terminal.

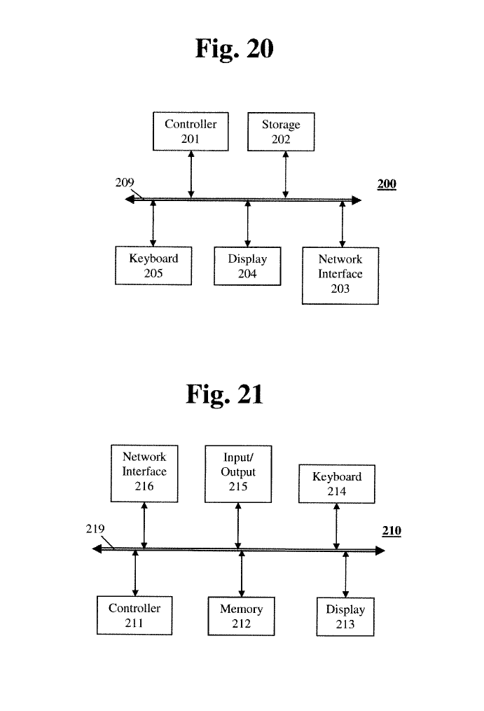

An example of a configuration of the network-connected device 32 (for example, as a computer) is shown schematically in FIG. 21. In FIG. 21, computer 210 includes a controller (or central processing unit) 211 that communicates with a number of other components, including memory 212, display 213, keyboard (and/or keypad) 214, other input/output (such as mouse, touchpad, stylus, microphone and/or speaker with voice/speech interface and/or recognition software, etc.) 215, and network interface 216, by way of internal bus 219.

The memory 212 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 216 provides a connection (for example, by way of an Ethernet connection or other network connection which supports any desired network protocol such as, but not limited to TCP/IP, IPX, IPX/SPX, or NetBEUI) to network 31.

A user interface may be provided and is configured through software natively or received through a network connection, to allow the user to access electronic data or content on the network-connected device and/or via the network, interact with network-connected devices and services (such as the device management apparatus 37), enjoy other software-driven functionalities, etc. For example, a browser (such as Internet Explorer™, Netscape Navigator™, a proprietary browser, etc.) may be provided on the client terminal so that a user of the client terminal can use browsing operations to communicate with the device management apparatus 37, and access other data or content.

Additional aspects or components of the computer 210 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

As mentioned above, network-connected device 32 is not limited to a personal computer, but can be manifested in a form of any of various devices that can be configured to communicate over a network and/or the Internet.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

What is claimed is:

1. A device management apparatus for managing a network-connected device including an RFID tag, said device management apparatus comprising:
a management information generation part configured to generate device location information indicating a location of the network-connected device, based on at least one detection signal from an RFID sensor indicating a location of the RFID tag, the detection signal being communicated to the device management apparatus via the network; and
a device installer configured to register a device location attribute corresponding to the network-connected device, wherein the device installer automatically registers the device location information generated by the management information generation part as the device location attribute corresponding to the network-connected device.

2. The device management apparatus of claim 1, wherein the device management apparatus receives tag identification information identifying the RFID tag from the network-connected device via the network, and
the management information generation part generates the device location information after the RFID sensor receives identifying information from the RFID tag that matches the tag identification information received from the network-connected device.

3. The device management apparatus of claim 1, wherein the management information generation part maintains sensor information identifying the RFID sensor and a corresponding sensor location of the RFID sensor, and
if the RFID sensor detects the RFID tag, the management information generation part generates the device location information based on the corresponding sensor location of the RFID sensor.

4. The device management apparatus of claim 1, wherein the device installer includes a user interface configured for user entry of the device location attribute corresponding to the network-connected device, and the user interface automatically enters the device location information generated by the management information generation part as the device location attribute corresponding to the network-connected device.

5. The device management apparatus of claim 1, wherein when the network-connected device is moved, the device location information generated by the management information generation part is updated to reflect an updated location of the network-connected device.

6. The device management apparatus of claim 1, wherein the management information generation part generates a history log indicating changes in the location of the network-connected device.

7. The device management apparatus of claim 1, wherein after the RFID sensor first detects the RFID tag at a first time, the management information generation part generates device management information indicating that the network-connected device was installed at the first time.

8. The device management apparatus of claim 1, wherein after the RFID sensor first detects the RFID tag at a first time, the device installer automatically registers the first time as a device installation time attribute corresponding to the network-connected device.

9. The device management apparatus of claim 1, wherein the management information generation part generates tag location information indicating the location of the RFID tag, based on said at least one detection signal from the RFID sensor, and the device location information is generated based on the tag location information.

10. A method for managing a network-connected device by a device management apparatus, the network-connected device including an RFID tag, said method comprising:
generating device location information indicating a location of the network-connected device, based on at least one detection signal from an RFID sensor indicating a location of the RFID tag, the detection signal being communicated to the device management apparatus via the network; and
automatically registering the device location information as a device location attribute corresponding to the network-connected device, by a device installer of the device management apparatus.

11. The method of claim 10, further comprising receiving tag identification information identifying the RFID tag from the network-connected device via the network,
wherein the device location information is generated after the RFID sensor receives identifying information from the RFID tag that matches the tag identification information received from the network connected device.

12. The method of claim 10, further comprising maintaining sensor information identifying the RFID sensor and a corresponding sensor location of the RFID sensor,
wherein if the RFID sensor detects the RFID tag, the device location information is generated based on the corresponding sensor location of the RFID sensor.

13. The device management apparatus of claim 10, further comprising automatically entering the device location information as the device location attribute corresponding to the network-connected device, in a user interface of the device installer configured for user entry of the device location attribute.

14. The method of claim 10, further comprising updating the device location information to reflect an updated location of the network-connected device, if the network-connected device is moved.

15. The method of claim 10, further comprising generating a history log indicating changes in the location of the network-connected device.

16. The method of claim 10, further comprising generating device management information indicating that the network-connected device was installed at a first time, if the RFID sensor first detects the RFID tag at the first time.

17. The method of claim 10, further comprising registering, by the device installer of the device management apparatus, a first time as a device installation time attribute corresponding to the network-connected device, if the RFID sensor first detects the RFID tag at the first time.

18. The method of claim 10, further comprising generating tag location information indicating the location of the RFID tag, based on said at least one detection signal from the RFID sensor, wherein the device location information is generated based on the tag location information.

19. A device management system comprising:
a network-connected device including an RFID tag;
an RFID sensor; and
a device management apparatus including:
a management information generation part configured to generate device location information indicating a location of the network-connected device, based on at least one detection signal from the RFID sensor indicating a location of the RFID tag; and
a device installer configured to register a device location attribute corresponding to the network-connected device, wherein the device installer automatically registers the device location information generated by the management information generation part as the device location attribute corresponding to the network-connected device.
